(19) United States
(12) Patent Application Publication
(10) Pub. No.: US 2008/0241055 A1
(43) Pub. Date: Oct. 2, 2008

(54) METHOD FOR PRODUCING IRON OXYHYDROXIDE PARTICLE

(75) Inventors: Mika Kawase, Tokyo (JP); Mamoru Satoh, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Tokyo (JP)

(21) Appl. No.: 12/051,915

(22) Filed: Mar. 20, 2008

(30) Foreign Application Priority Data
Mar. 27, 2007 (JP) 2007-082059

(51) Int. Cl. C01G 49/02

(52) U.S. Cl. 423/632

(57) ABSTRACT

First, a ferrous iron-containing suspension solution is obtained by mixing an aqueous ferrous salt solution and an aqueous alkali solution containing one or two of an alkali carbonate and an alkali hydroxide. Then, an iron oxyhydroxide particle precursor is obtained by blowing an oxygen-containing gas having an oxygen component proportion of 0.5 to 0.8 into the suspension solution thus obtained to oxidize the ferrous iron in the suspension solution at an oxidation rate of 30 to 65% while the suspension solution is being controlled to fall in a temperature range of −5° C. or higher and lower than 10° C. Thereafter, the iron oxyhydroxide particles 2 are produced from the iron oxyhydroxide particle precursor by blowing an oxygen-containing gas into the suspension solution containing the iron oxyhydroxide particle precursor while the suspension solution is being controlled to fall in a temperature range of 20° C. or higher and lower than 45° C.

### BACKGROUND OF THE INVENTION

1. Field of the Invention

The present invention relates to an iron oxyhydroxide particle to be suitably used as a precursor for a magnetic particle for use in a high density, high capacity magnetic recording tape, and in particular, to a method for producing an iron oxyhydroxide particle that is fine, large in aspect ratio and narrow in particle size distribution.

2. Description of the Related Art

In high density, high capacity magnetic recording tapes that have been required to be increasingly improved in performance year by year, the bit length and the track width become smaller with increasing recording densities. In other words, the high densification is achieved by improving the recording density and the track density. However, when the bit length and the track width become smaller, the number of magnetic substance particles per one bit is decreased to degrade the S/N ratio. Further, when the particle size varies, the distribution condition of the magnetic substance particles becomes nonuniform to enhance the noise. Accordingly, for the purpose of achieving high densification, it is required to form particles that are fine and uniform in particle size.

A wet synthesis method has been known as a method for obtaining an iron oxyhydroxide particle that is a precursor for a needle-like magnetic particle. The wet synthesis method produces the iron oxyhydroxide particles by subjecting to an oxidation treatment the ferrous hydroxide obtained by mixing under stirring an aqueous solution of an iron raw material and a neutralizing agent. Next, the iron oxyhydroxide particles are subjected to a reduction treatment to yield needle-like magnetic particles containing Fe as a constituent element. For the purpose of obtaining the demanded fine needle-like magnetic particles, it is important to control the oxidation conditions in the step of forming the ferrous hydroxide nuclei. In order to meet this requirement, there have hitherto been proposed, for example, a method in which the oxygen partial pressure in an oxidative gas is set to be 0.2 atm or more and thereby the oxidation speed is controlled (for example, Japanese Patent Laid-Open No. 3-228829), a method in which the oxidation step is divided into two stages and further the oxidation speed is varied (for example, Japanese Patent Laid-Open No. 10-182162), and a method in which the oxidation temperature is controlled (for example, Japanese Patent Laid-Open No. 6-24750).

However, in above Japanese Patent Laid-Open No. 3-228829, it is described that with a stirred tank reactor or a bubble column reactor, stable preparation of fine goethite is hardly actualized, and thus the method in Japanese Patent Laid-Open No. 3-228829 is not a method that uses a stirred tank reactor. Accordingly, the oxidative gas having the oxygen partial pressure of 0.2 atm or more is blown without stirring, and hence there is a possibility that the particle size of the obtained iron oxyhydroxide particles is varied. In above Japanese Patent Laid-Open No. 10-182162, the oxidation speed is changed to a predetermined oxidation speed while the oxidation speed is being increased in the step of oxidizing ferrous oxide, and hence there is a possibility that the particle size of the iron oxyhydroxide particles is varied. Additionally, the long axis length of the obtained goethite is approximately 0.05 to 0.25 μm to be insufficiently fine. Further, in above Japanese Patent Laid-Open No. 6-24750, exclusion of the generation of dendritic particles is a main object, and fine particles are also intended to obtain. The oxidation temperature is set at 10° C. or higher; however, the oxidation at this temperature facilitates the growth of green rust to be nuclei for iron oxyhydroxide, and hence there is a possibility that the particle size of the obtained iron oxyhydroxide tends to be too large.

### SUMMARY OF THE INVENTION

The present invention was achieved on the basis of such technical problems as described above, and takes as its object the provision of an iron oxyhydroxide particle that is fine to specifically have a mean long axis length of 75 nm or less, large in aspect ratio to be specifically 3 or more, and narrow in particle size distribution.

The present inventors reviewed the production conditions of iron oxyhydroxide particles from a viewpoint completely different from the viewpoint of the conventional knowledge. Consequently, the present inventors found that, in a wet synthesis method, for the purpose of making iron oxyhydroxide particles fine, increasing the aspect ratio of the iron oxyhydroxide particles and narrowing the particle size distribution of the iron oxyhydroxide particles, it is recommended that part of the ferrous raw material is oxidized at a lower temperature to produce an iron oxyhydroxide particle precursor, and the precursor is oxidized at a higher temperature so as to grow the iron oxyhydroxide particles by using the rest of the ferrous raw material. Specifically, the present invention is a method for producing an iron oxyhydroxide particle, the method including: a step A of obtaining a ferrous iron-containing suspension solution by mixing an aqueous ferrous salt solution and an aqueous alkali solution containing one or two of an alkali carbonate and an alkali hydroxide; a step B of obtaining an iron oxyhydroxide particle precursor by blowing an oxygen-containing gas having an oxygen component proportion of 0.5 to 0.8 into the suspension solution obtained in the step A to oxidize the ferrous iron in the suspension solution at an oxidation rate of 30 to 65% while the suspension solution is being controlled to fall in a temperature range of −5° C. or higher and lower than 10° C.; and a step C of producing iron oxyhydroxide particles from the iron oxyhydroxide particle precursor, after the step B, by blowing an oxygen-containing gas into the suspension solution containing the iron oxyhydroxide particle precursor while the suspension solution is being controlled to fall in a temperature range of 20° C. or higher and lower than 45° C.

Here, it is to be noted that iron oxyhydroxide as referred to in the present invention means α-iron oxyhydroxide (α-FeOOH: goethite), the oxygen component proportion means the volume proportion of the oxygen contained in a unit volume, and ferrous iron means Fe²⁺

In the step A of the present invention, the concentration of Fe in the ferrous iron-containing suspension solution is preferably 0.001 to 0.1 mol/L. This is for the purpose of ensuring the yield of the iron oxyhydroxide particles and obtaining fine particles.

In the step A of the present invention, the hydrogen ion index pH (hereinafter, simply referred to as “pH”) of the aqueous alkali solution is preferably 9 to 11. This is for the purpose of ensuring the yield of the iron oxyhydroxide particles and reducing the intermingling of hetero-phase particles such as maghemite particles and magnetite particles.

In the step B of the present invention, the diameter of the gas bubble in the oxygen-containing gas is preferably less than 2.0 mm. This is for the purpose of ensuring the yield of the iron oxyhydroxide particles and obtaining fine particles by increasing the contact area between the ferrous iron and the oxygen-containing gas.

In the step C of the present invention, the oxygen component proportion in the oxygen-containing gas is preferably 0.2 to 0.8. This is for the purpose of ensuring the yield of the iron oxyhydroxide particles and obtaining fine particles.

In the present invention, the iron oxyhydroxide particles obtained in the step C is preferably 20 to 50 nm in mean long axis length and 3 to 10 in aspect ratio.

The iron oxyhydroxide particles obtained in the step C preferably have a needle-like or spindle-like shape. By applying a reduction treatment to the iron oxyhydroxide particles obtained in the step C, the iron oxyhydroxide particles obtained in the step C can be converted into metal magnetic particles; in this case, even the spindle-like iron oxyhydroxide particles take a needle-like shape after the reduction treatment. The needle-like iron oxyhydroxide particles also take needle-like shape after the reduction treatment.

According to the present invention, as described above, there can be provided an iron oxyhydroxide particle that has a mean long axis length of 75 nm or less, preferably 50 nm or less, and is large in aspect ratio to be specifically 3 or more and narrow in particle size distribution. It is to be noted that the aspect ratio is the ratio of the mean long axis length to the mean short axis length.

### BRIEF DESCRIPTION OF THE DRAWING

FIG. 1 is a diagram schematically illustrating how iron oxyhydroxide particles are produced by way of green rust.

### DETAILED DESCRIPTION OF THE PREFERRED EMBODIMENTS

Hereinafter, the best mode for carrying out the present invention is described in detail. The method for producing an iron oxyhydroxide particle of the present invention includes: a step A of obtaining a ferrous iron-containing suspension solution by mixing an aqueous ferrous salt solution and an aqueous alkali solution containing one or two of an alkali carbonate and an alkali hydroxide; a step B of obtaining an iron oxyhydroxide particle precursor by blowing an oxygen-containing gas having an oxygen component proportion of 0.5 to 0.8 into the suspension solution obtained in the step A to oxidize the ferrous iron in the suspension solution at an oxidation rate of 30 to 65% while the suspension solution is being controlled to fall in a temperature range of −5° C. or higher and lower than 10° C.; and a step C of producing iron oxyhydroxide particles from the iron oxyhydroxide particle precursor, after the step B, by blowing an oxygen-containing gas into the suspension solution containing the iron oxyhydroxide particle precursor while the suspension solution is being controlled to fall in a temperature range of 20° C. or higher and lower than 45° C. These steps are sequentially described below.

Step A

<Aqueous Ferrous Salt Solution>

As the ferrous salt for obtaining the aqueous ferrous salt solution, there can be used ferrous salts having divalent iron such as ferrous sulfate (FeSO₄) and ferrous chloride (FeCl₂).

When the concentration of the ferrous iron (Fe²⁺) (hereinafter, referred to as Fe concentration) in the ferrous iron-containing suspension solution is high, the particle size of the finally produced iron oxyhydroxide particles is increased, and hence the Fe concentration is preferably set at 0.1 mol/L or less and more preferably 0.05 mol/L or less. On the other hand, when the Fe concentration is too low, the number of the produced iron oxyhydroxide particles is extremely reduced to decrease the yield, and hence such a low Fe concentration is not appropriate for an industrial production method. Accordingly, the Fe concentration in the ferrous iron-containing suspension solution is preferably set at 0.001 mol/L or more and more preferably 0.01 mol/L or more.

<Aqueous Alkali Solution>

In the present invention, there is prepared the aqueous alkali solution to function as a neutralizing agent for the above-described aqueous ferrous salt solution. As the aqueous alkali solution, one or two of an aqueous alkali carbonate solution and an aqueous alkali hydroxide solution are used.

As the alkali carbonate, at least one of ammonium carbonate ((NH₄)₂CO₃), ammonium hydrogen carbonate ((NH₄)HCO₃), sodium hydrogen carbonate (NaHCO₃), sodium carbonate (Na₂CO₃) and potassium carbonate (K₂CO₃) can be used. Preferred among these is sodium hydrogen carbonate.

As the alkali hydroxide, at least one of sodium hydroxide (NaOH), ammonium hydroxide (NH₄OH) and potassium hydroxide (KOH) can be used. Preferred among these is sodium hydroxide.

In the neutralization, the alkali concentration of the aqueous alkali solution is preferably set to be excessive relative to the alkali equivalent to the ferrous iron. This is because in the vicinity of the equivalent, granular magnetite tends to be generated, and with an alkali amount smaller than the equivalent, the yield is less than the yield corresponding to the fed amount of Fe, and additionally the Fe ion remains in the waste solution, thus the disposal of the waste solution being required.

The pH of the aqueous alkali solution is preferably set to fall in a range from 9 to 11 and more preferably from 9.5 to 10.5. When the pH is less than 9, the obtained iron oxyhydroxide particles become indeterminate-shape to reduce the yield of the iron oxyhydroxide fine particles, and hence such a pH is not appropriate for an industrial production method. When the pH exceeds 11, the iron oxyhydroxide particles tend to grow in the long axis direction, and hence no fine iron oxyhydroxide particles having a desired size can be obtained.

In the present invention, the alkali carbonate has an effect to suppress the growth of the iron oxyhydroxide particles in the long axis direction. On the other hand, the alkali hydroxide that is a stronger alkali than the alkali carbonate has a feature that a product due to a neutralization reaction is readily obtained.

<Neutralization>

A neutralization reaction is carried out by mixing the aqueous ferrous salt solution prepared in the above-described manner and the aqueous alkali solution containing one or two of an alkali carbonate and an alkali hydroxide. This neutralization reaction is preferably carried out in an airtight vessel from which oxygen has been removed, namely, the interior of which is made to have a nonoxidative atmosphere.

For example, when ferrous sulfate as the ferrous salt, sodium hydrogen carbonate as the alkali carbonate and sodium hydroxide as the alkali hydroxide are used, the following neutralization reaction occurs. This reaction produces ferrous carbonate (FeCO₃, iron(II) carbonate), ferrous bicarbonate (Fe(HCO₃)₂, iron(II) bicarbonate) and ferrous hydroxide (Fe(OH)₂, iron(II) hydroxide).

FeSO₄+NaHCO₃→FeCO₃+NaHSO₄

FeSO₄+2NaHCO₃→Fe(HCO₃)₂+Na₂SO₄

FeSO₄+2NaOH→Fe(OH)₂+Na₂SO₄

For the purpose of immediately moving to the next step B of obtaining the iron oxyhydroxide particle precursor, the processing temperature of the neutralization reaction is preferably set at the temperature at which the step B is carried out. In the present invention, the step B is carried out in a temperature range of −5° C. or higher and lower than 10° C., and hence the neutralization reaction is preferably carried out in an equivalent temperature range. The time of the neutralization reaction is set at 60 minutes or less, preferably 30 minutes or less, for the purpose of preventing unnecessary growth and agglomeration of the neutralization products such as the ferrous hydroxide particles.

Step B

An oxygen-containing gas is blown into the suspension solution containing the ferrous carbonate, ferrous bicarbonate and ferrous hydroxide prepared in the above-described manner. This blowing of the oxygen-containing gas oxidizes the ferrous carbonate, ferrous bicarbonate and ferrous hydroxide to produce the iron oxyhydroxide particle precursor. At this stage, in the production of the iron oxyhydroxide particle precursor, part of the ferrous iron in the suspension solution is oxidized instead of oxidizing all the ferrous iron in the suspension solution. Specifically, the oxidation proportion in relation to the total amount of the ferrous iron in the ferrous salts used as the raw materials, namely, the oxidation rate is set at 30 to 65% and more preferably at 35 to 50%. When the oxidation rate of the ferrous iron is less than 30%, the iron oxyhydroxide particles tend to grow in the long axis direction, and hence no fine iron oxyhydroxide particles having a desired size can be obtained. On the other hand, when the oxidation rate exceeds 65%, the iron oxyhydroxide particles become indeterminate-shape to reduce the yield of the iron oxyhydroxide fine particles, and hence such an oxidation rate is not appropriate for an industrial production method. It is to be noted that the oxidation rate can be regulated by controlling the time of the blowing of the oxygen-containing gas into the suspension solution. The oxidation rate increases with the increase of the blowing time. Additionally, the oxidation rate is determined as follows. First, the amount denoted by y is the amount of the oxygen required for oxidizing the whole amount of the ferrous iron in the suspension solution. The amount denoted by x is the amount of the oxygen consumed in the oxidation which is determined from the difference between the amount of the oxygen in the oxygen-containing gas introduced into the suspension solution and the amount of the oxygen in the oxygen-containing gas made to pass through the suspension solution. Thus, the oxidation rate is defined as the value calculated from y and x by using the formula x/y×100(%).

The oxygen-containing gas is preferably given the oxygen component proportion set to fall in a range from 0.5 to 0.8. When the oxygen component proportion is less than 0.5, the oxidation proceeds slowly, the obtained iron oxyhydroxide particle precursor grows to be large, and hence no iron oxyhydroxide particles having a desired size can be obtained. On the other hand, when the oxygen component proportion exceeds 0.8, the iron oxyhydroxide particles become indeterminate-shape to reduce the yield of the iron oxyhydroxide particles, and hence such an oxygen component proportion is not appropriate for an industrial production method. As the oxygen-containing gas, a mixed gas composed of oxygen and an inert gas such as nitrogen can be used. Additionally, when sodium hydroxide as the alkali hydroxide is not used as the neutralizing agent, the target of the oxidation includes ferrous carbonate and ferrous bicarbonate.

The iron oxyhydroxide particle precursor is generally referred to as green rust (S. H. DRISSI, Ph. REFAIT et al., Corrosion Science, vol. 37, No. 12, p. 2025 (1995)). According to S. H. DRISSI, Ph. REFAIT et al., Corrosion Science, vol. 37, No. 12, p. 2025 (1995), green rust includes two types, namely, GR1 that contains a carbonate ion and has a chemical formula (stoichiometric composition) [Fe₄^{(II)}Fe₂^{(III)}(OH)₁₂][CO₃.2H₂O] and GR2 that contains a sulfate ion and has a chemical formula (stoichiometric composition) [Fe₄^{(II)}Fe₂^{(III)}(OH)₁₂][SO₄.2H₂O]. The iron oxyhydroxide particle precursor in the present invention is also GR1 or GR2. It is to be noted that the hydroxyl group OH⁻ in green rust is generated by the electrolytic dissociation of the alkali carbonate. Iron oxyhydroxide is produced through green rust as the reaction intermediate.

In the present invention, the oxygen-containing gas is blown into the suspension solution under the condition that the temperature of the suspension solution is being maintained in a range of −5° C. or higher and lower than 10° C., preferably in a range from 0 to 5° C. By setting the temperature of the suspension solution into which the oxygen-containing gas is blown to be lower than 10° C., preferably 5° C. or lower, the particle size of green rust can be made small, and consequently the particle size (long axis length) of the iron oxyhydroxide particles can be reduced. However, when the temperature of the suspension solution is 10° C. or higher, the generation and growth of green rust proceed in parallel, and accordingly the particle size of the iron oxyhydroxide particles become large. On the other hand, when the temperature of the suspension solution is lower than −5° C., the suspension solution freezes to make the generation of green rust insufficient.

Additionally, the oxygen-containing gas is preferably blown in as a gas bubble having a diameter of 0.5 mm or more and less than 2.0 mm, preferably a diameter of 1.0 to 1.5 mm. When the diameter of the gas bubble is less than 0.5 mm, the area of the gas-liquid interface becomes large, the oxidation speed becomes excessively fast so as to make it difficult to obtain the oxidation precipitate of the iron oxyhydroxide, thus the yield of the iron oxyhydroxide fine particles is reduced, and hence such a gas bubble diameter is not appropriate for an industrial production method. On the other hand, when the diameter of the gas bubble is 2.0 mm or more, the staying time of the gas bubble in the solution becomes short and the area of the gas-liquid interface becomes small to decrease the contact proportion with the ferrous iron, and hence the oxidation reaction is suppressed to make the particle size of the iron oxyhydroxide particles larger than the desired particle size. It is to be noted that the diameter of the gas bubble can be measured by taking with camera an image of the gas bubble blown into the suspension solution.

Additionally, while the oxygen-containing gas is being introduced into the suspension solution, the suspension solution is preferably stirred. This stirring may be carried out with the introduced gas or forcibly with a stirrer.

Step C

Under the condition that the suspension solution in which green rust has been generated is increased in temperature so as for the temperature of the suspension solution to be controlled at 20° C. or higher and lower than 45° C., preferably 25° C. or higher and lower than 35° C., the oxygen-containing gas is blown into the suspension solution. The blowing of the oxygen-containing gas oxidizes the iron oxyhydroxide particle precursor to produce the iron oxyhydroxide particles. When the temperature of the suspension solution is lower than 20° C., the iron oxyhydroxide particles become indeterminate-shape to reduce the yield of the iron oxyhydroxide fine particles, and hence such a temperature of the suspension solution is not appropriate for an industrial production method. On the other hand, when the temperature of the suspension solution is 45° C. or higher, hetero-phases such as hematite are inappropriately intermingled.

In the oxygen-containing gas, the oxygen component proportion preferably falls in a range from 0.2 to 0.8, and more preferably in a range from 0.5 to 0.8. When the oxygen component proportion is less than 0.2, the oxidation proceeds slowly, the obtained iron oxyhydroxide particles grow to be large, and hence no iron oxyhydroxide particles having a desired size can be obtained. On the other hand, when the oxygen component proportion exceeds 0.8, the iron oxyhydroxide particles become indeterminate-shape, namely, does not become needle-like or spindle-like to consequently reduce the yield of the iron oxyhydroxide fine particles, and hence such an oxygen component proportion is not appropriate for an industrial production method.

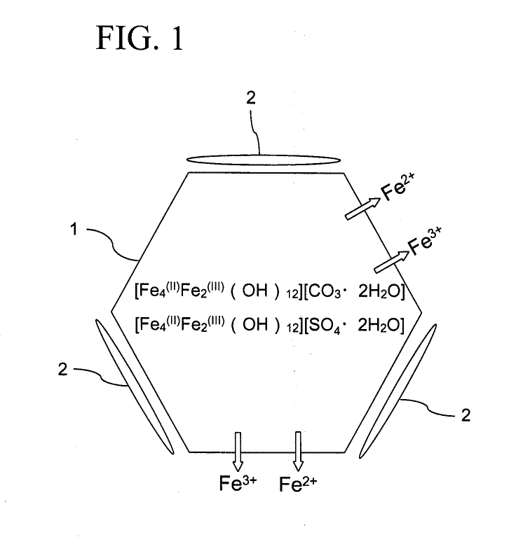

Here is described the dissolution-precipitation reaction on the basis of FIG. 1. FIG. 1 schematically illustrates the green rust 1 present in the suspension solution. The green rust 1 has a hexagonal plate shape. In the suspension solution having an adjusted pH, ferrous iron (Fe²⁺) and ferric iron (Fe³⁺) are dissolved from the green rust 1 into the suspension solution. Meanwhile, when the suspension solution becomes supersaturated with ferrous iron (Fe²⁺) and ferric iron (Fe³⁺), ferrous iron (Fe²⁺) and ferric iron (Fe³⁺) are precipitated in the suspension solution. The ferrous iron (Fe²⁺) precipitated in the suspension solution is oxidized to produce the iron oxyhydroxide particles 2. This oxidation is allowed to proceed, as the step B, by blowing of the oxygen-containing gas. The series of the processes in which the iron oxyhydroxide particles 2 is produced through the green rust 1 is referred to as aging as the case may be.

As for the iron oxyhydroxide particles 2 produced through the green rust 1, it is understood that the long axis length of the iron oxyhydroxide particles 2 grows along the side of the green rust 1. Accordingly, by reducing the size of the green rust 1, the long axis length of the iron oxyhydroxide particles 2 can be shortened.

The above-described series of steps produce the needle-like or spindle-like iron oxyhydroxide particles that serve as a so-called metal magnetic particle precursor. The produced iron oxyhydroxide particles have a mean long axis length of 75 nm or less, in particular, a mean long axis length of 50 nm or less, additionally have an aspect ratio as large as 3 or more, and are narrow in particle size distribution although the particles are fine.

The iron oxyhydroxide particles can be produced in the above-described manner; however, for the purpose of converting the iron oxyhydroxide particles into metal magnetic particles, the iron oxyhydroxide particles are subjected to a reduction treatment. In such a reduction treatment, the iron oxyhydroxide particles may be maintained in a flow of a reductive gas such as hydrogen gas, at 300 to 600° C. for 0.25 to 72 hours. Further, by applying a nitriding treatment in a gas such as NH₃ gas, the iron oxyhydroxide particles may be converted into iron nitride magnetic particles. Subsequently, by using a gas such as a gas containing a small amount of oxygen, a thin oxide film can be formed on the surface of the magnetic particles or the iron nitride magnetic particles. The metal magnetic particles thus obtained are needle-like magnetic particles having a mean long axis length of 75 nm or less, in particular, a mean long axis length of 50 nm or less, and are narrow in particle size distribution.

### EXAMPLE 1

By using ferrous sulfate heptahydrate (FeSO₄.7H₂O) as a ferrous salt to be the iron raw material, an aqueous solution of ferrous sulfate was prepared in such a way that the concentration (Fe concentration) of the ferrous iron-containing suspension solution was 0.05 mol/L. As neutralizing agents, sodium hydrogen carbonate (NaHCO₃) and sodium hydroxide (NaOH) were prepared in amounts of 4 equivalents and 2 equivalents, respectively, in relation to the iron raw material. Neutralization and precipitation were carried out by adding the aqueous solution of ferrous sulfate to an aqueous alkali solution of pH 12 obtained by mixing under stirring these neutralizing agents with ion-exchanged water, and thus a suspension solution was obtained (step A). It is to be noted that the temperature was controlled in such a way that the solution temperature was 0° C. and constant during and after the neutralization. The Fe concentration in the ferrous iron-containing suspension solution was 0.05 mol/L. The neutralization produced ferrous carbonate, ferrous hydroxide and ferrous bicarbonate. The neutralization was carried out in a nonoxidative atmosphere prepared by using nitrogen as the atmosphere gas.

While the suspension solution was being stirred for mixing, an oxygen-containing gas having an oxygen component proportion of 0.5 was blown as gas bubbles of 2.5 mm in diameter into the suspension solution to oxidize the ferrous carbonate, ferrous hydroxide and ferrous bicarbonate. This oxidation treatment produced green rust that was an iron oxyhydroxide particle precursor (step B). In this case, even during the blowing of the oxygen-containing gas, the temperature of the suspension solution was controlled at 0° C. In this oxidation step, the oxidation rate of the ferrous iron was adjusted at 40%.

Further, the residual oxygen-containing gas in the reactor was replaced with a nonoxidative gas, and then the suspension solution was increased in temperature to 30° C. Thereafter, while the temperature of the suspension solution was being controlled at 30° C., another oxygen-containing gas having an oxygen component proportion of 0.1 was blown into the suspension solution to oxidize the remaining 60% of the ferrous iron (step C) to yield needle-like or spindle-like iron oxyhydroxide fine particles.

For the obtained iron oxyhydroxide particles, the long axis length, the aspect ratio and the particle size distribution were determined. As for the particle size of the iron oxyhydroxide particles, the long axis length and the short axis length were measured for each of 100 particles with a TEM (Transmission Electron Microscope). The mean value of the long axis lengths measured for 100 particles was taken as the mean long axis length, and the mean value of the short axis lengths measured for 100 particles was taken as the mean short axis length. The aspect ratio was obtained from these mean long axis length and mean short axis length. Further, the particle size distribution was obtained as the ratio of the standard deviation of the long axis length to the mean long axis length (standard deviation of the long axis length/mean long axis length, CV) based on the measured values of 100 particles. The smaller is the CV value, the smaller is the particle size variation. By TEM observation, an examination whether or not indeterminate-shape particles were present in the obtained iron oxyhydroxide particles was also carried out. An examination whether or not the hetero phase particles, namely, maghematite particles and hematite particles were present in the iron oxyhydroxide particles was also carried out. The examination was carried out by qualitatively analyzing the XRD (X-ray diffraction) peaks and by checking the presence/absence of the individual peaks of iron oxyhydroxide, maghematite and hematite. The results obtained as described above are shown in Table 1.

### EXAMPLE 2

Iron oxyhydroxide particles were obtained in the same manner as in Example 1 except that in the step A, the pH of the aqueous alkali solution was set at 10.

For the iron oxyhydroxide particles, the same measurements as in Example 1 were carried out. The results thus obtained are shown in Table 1.

### EXAMPLE 3

Iron oxyhydroxide particles were obtained in the same manner as in Example 1 except that: in the step A, the pH of the aqueous alkali solution was set at 10; and in the step B, the oxygen-containing gas was blown as gas bubbles of 1.7 mm in diameter into the suspension solution.

For the iron oxyhydroxide particles, the same measurements as in Example 1 were carried out. The results thus obtained are shown in Table 1.

### EXAMPLE 4

Iron oxyhydroxide particles were obtained in the same manner as in Example 1 except that: in the step A, the pH of the aqueous alkali solution was set at 10; in the step B, while the temperature of the suspension solution was being controlled at 5° C., the oxygen-containing gas was blown as gas bubbles of 1.7 mm in diameter into the suspension solution; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 5

Iron oxyhydroxide particles were obtained in the same manner as in Example 1 except that: in the step A, the pH of the aqueous alkali solution was set at 10; in the step B, while the temperature of the suspension solution was being controlled at 8° C., the oxygen-containing gas was blown as gas bubbles of 1.7 mm in diameter into the suspension solution; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 6

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 7

Iron oxyhydroxide particles were obtained in the same manner as in Example 1 except that: in the step A, the pH of the aqueous alkali solution was set at 10; in the step B, while the temperature of the suspension solution was being controlled at −3° C., the oxygen-containing gas was blown as gas bubbles of 1.7 mm in diameter into the suspension solution; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 8

Iron oxyhydroxide particles were obtained in the same manner as in Example 1 except that: in the step A, the pH of the aqueous alkali solution was set at 10; in the step B, an oxygen-containing gas having an oxygen component proportion of 0.8 was blown as gas bubbles of 1.7 mm in diameter into the suspension solution; and in the step C, the oxygen-containing gas having an oxygen component proportion of 0.8 was blown into the suspension solution.

For the iron oxyhydroxide particles, the same measurements as in Example 1 were carried out. The results thus obtained are shown in Table 1.

### EXAMPLE 9

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution to adjust the oxidation rate of the ferrous iron at 63%; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 10

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution; and in the step C, while the temperature of the suspension solution was being controlled at 35° C., the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 11

Iron oxyhydroxide particles were obtained in the same manner as in Example 1 except that: in the step A, the pH of the aqueous alkali solution was set at 10; in the step B, the oxygen-containing gas was blown as gas bubbles of 1.0 mm in diameter into the suspension solution; and in the step C, the oxygen-containing gas having an oxygen component proportion of 0.5 was blown into the suspension solution.

For the iron oxyhydroxide particles, the same measurements as in Example 1 were carried out. The results thus obtained are shown in Table 1.

### EXAMPLE 12

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution; and in the step C, the oxygen-containing gas having an oxygen component proportion of 0.2 was blown into the suspension solution.

For the iron oxyhydroxide particles, the same measurements as in Example 1 were carried out. The results thus obtained are shown in Table 1.

### COMPARATIVE EXAMPLE 1

Iron oxyhydroxide particles were obtained in the same manner as in Example 1 except that: in the step A, the Fe concentration of the ferrous iron-containing suspension solution was set at 0.15 mol/L; and in the step B, the oxidation rate of the ferrous iron was adjusted at 20%.

For the iron oxyhydroxide particles, the same measurements as in Example 1 were carried out. The results thus obtained are shown in Table 1.

### COMPARATIVE EXAMPLE 2

Iron oxyhydroxide particles were obtained in the same manner as in Example 1 except that: in the step A, the pH of the aqueous alkali solution was set at 10; in the step B, while the temperature of the suspension solution was being controlled at 30° C., the oxygen-containing gas was blown as gas bubbles of 1.7 mm in diameter into the suspension solution; and in the step C, the oxygen-containing gas having the oxygen component proportion of 0.5 was blown into the suspension solution.

For the iron oxyhydroxide particles, the same measurements as in Example 1 were carried out. The results thus obtained are shown in Table 1.

### COMPARATIVE EXAMPLE 3

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution to adjust the oxidation rate of the ferrous iron at 50%; and in the step C, while the temperature of the suspension solution was being controlled at 50° C., the oxygen-containing gas having the oxygen component proportion of 0.5 was blown into the suspension solution.

For the iron oxyhydroxide particles, the same measurements as in Example 1 were carried out. The results thus obtained are shown in Table 1.

### COMPARATIVE EXAMPLE 4

Iron oxyhydroxide particles were obtained in the same manner as in Example 1 except that: in the step A, the pH of the aqueous alkali solution was set at 8; in the step B, the oxygen-containing gas was blown as gas bubbles of 1.7 mm in diameter into the suspension solution to adjust the oxidation rate of the ferrous iron at 50%; and in the step C, while the temperature of the suspension solution was being controlled at 50° C., the oxygen-containing gas having the oxygen component proportion of 0.5 was blown into the suspension solution.

For the iron oxyhydroxide particles, the same measurements as in Example 1 were carried out. The results thus obtained are shown in Table 1.

### COMPARATIVE EXAMPLE 5

Iron oxyhydroxide particles were obtained in the same manner as in Example 1 except that: in the step A, the pH of the aqueous alkali solution was set at 10; in the step B, the oxygen-containing gas having an oxygen component proportion of 1.0 was blown as gas bubbles of 1.7 mm in diameter into the suspension solution; and in the step C, the oxygen-containing gas having the oxygen component proportion of 0.5 was blown into the suspension solution.

For the iron oxyhydroxide particles, the same measurements as in Example 1 were carried out. The results thus obtained are shown in Table 1.

### COMPARATIVE EXAMPLE 6

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution to adjust the oxidation rate of the ferrous iron at 67%; and in the step C, the oxygen-containing gas having the oxygen component proportion of 0.5 was blown into the suspension solution.

For the iron oxyhydroxide particles, the same measurements as in Example 1 were carried out. The results thus obtained are shown in Table 1.

### COMPARATIVE EXAMPLE 7

Iron oxyhydroxide particles were obtained in the same manner as in Example 1 except that: in the step A, the pH of the aqueous alkali solution was set at 10; in the step B, the oxygen-containing gas was blown as gas bubbles of 1.7 mm in diameter into the suspension solution; and in the step C, while the temperature of the suspension solution was being controlled at 15° C., the oxygen-containing gas having the oxygen component proportion of 0.5 was blown into the suspension solution.

For the iron oxyhydroxide particles, the same measurements as in Example 1 were carried out. The results thus obtained are shown in Table 1.

TABLE 1

| | | | | | | | | | Mean | | | |
|---|---|---|---|---|---|---|---|---|---|---|---|---|
| | Step A | | Step B | | | Step C | | Gas | long | | | |
| | Alkali | Fe con- | | Oxygen | Oxida- | | Oxygen | bubble | axis | | | |
| | solution: | centration | Temp. | component | tion | Temp. | component | diameter | length | Aspect | | |
| | pH | [mol/L] | [° C.] | proportion | rate [%] | [° C.] | proportion | [mm] | [nm] | ratio | CV | Remarks |
| Example 1 | 12 | 0.05 | 0 | 0.5 | 40 | 30 | 0.1 | 2.5 | 72 | 4.2 | 0.25 | |
| Example 2 | 10 | 0.05 | 0 | 0.5 | 40 | 30 | 0.1 | 2.5 | 65 | 4.0 | 0.26 | |
| Example 3 | 10 | 0.05 | 0 | 0.5 | 40 | 30 | 0.1 | 1.7 | 57 | 4.2 | 0.27 | |
| Example 4 | 10 | 0.05 | 5 | 0.5 | 40 | 30 | 0.5 | 1.7 | 45 | 3.8 | 0.20 | |
| Example 5 | 10 | 0.05 | 8 | 0.5 | 40 | 30 | 0.5 | 1.7 | 48 | 3.8 | 0.20 | |
| Example 6 | 10 | 0.05 | 0 | 0.5 | 40 | 30 | 0.5 | 1.7 | 40 | 3.7 | 0.19 | |
| Example 7 | 10 | 0.05 | −3 | 0.5 | 40 | 30 | 0.5 | 1.7 | 40 | 4.0 | 0.20 | |
| Example 8 | 10 | 0.05 | 0 | 0.8 | 40 | 30 | 0.8 | 1.7 | 39 | 3.5 | 0.20 | |
| Example 9 | 10 | 0.05 | 0 | 0.5 | 63 | 30 | 0.5 | 1.7 | 23 | 5.0 | 0.16 | |
| Example 10 | 10 | 0.05 | 0 | 0.5 | 40 | 35 | 0.5 | 1.7 | 36 | 3.3 | 0.18 | |
| Example 11 | 10 | 0.05 | 0 | 0.5 | 40 | 30 | 0.5 | 1.0 | 30 | 3.7 | 0.20 | |
| Example 12 | 10 | 0.05 | 0 | 0.5 | 40 | 30 | 0.2 | 1.7 | 46 | 4.2 | 0.17 | |
| Comparative | 12 | 0.15 | 0 | 0.5 | 20 | 30 | 0.1 | 2.5 | 90 | 4.5 | 0.26 | |
| Example 1 | | | | | | | | | | | | |
| Comparative | 10 | 0.05 | 30 | 0.5 | 40 | 30 | 0.5 | 1.7 | 120 | 4.0 | 0.17 | |
| Example 2 | | | | | | | | | | | | |
| Comparative | 10 | 0.05 | 0 | 0.5 | 50 | 50 | 0.5 | 1.7 | — | — | — | Hematite |
| Example 3 | | | | | | | | | | | | generated |
| Comparative | 8 | 0.05 | 0 | 0.5 | 50 | 50 | 0.5 | 1.7 | — | — | — | Only |
| Example 4 | | | | | | | | | | | | indeterminate- |
| | | | | | | | | | | | | shape |
| | | | | | | | | | | | | substance |
| Comparative | 10 | 0.05 | 0 | 1.0 | 40 | 30 | 0.5 | 1.7 | — | — | — | Only |
| Example 5 | | | | | | | | | | | | indeterminate- |
| | | | | | | | | | | | | shape |
| | | | | | | | | | | | | substance |
| Comparative | 10 | 0.05 | 0 | 0.5 | 67 | 30 | 0.5 | 1.7 | — | — | — | Only |
| Example 6 | | | | | | | | | | | | indeterminate- |
| | | | | | | | | | | | | shape |
| | | | | | | | | | | | | substance |
| Comparative | 10 | 0.05 | 0 | 0.5 | 40 | 15 | 0.5 | 1.7 | — | — | — | Only |
| Example 7 | | | | | | | | | | | | indeterminate- |
| | | | | | | | | | | | | shape |
| | | | | | | | | | | | | substance |

From Table 1, the following have been clarified.

As can be seen, in the case where the temperature (the temperature in the step B) of the suspension solution at the time of the air blowing after neutralization is 30° C. (Comparative Example 2), the long axis length is 120 nm; however, in the cases where the temperature concerned is lower than 10° C., the long axis length is 72 nm or less so as to yield fine iron oxyhydroxide particles. Further, as can be seen, in the case where the temperature of the suspension solution in the step C is 15° C. (Comparative Example 7) or 50° C. (Comparative Example 3), the iron oxyhydroxide is indeterminate-shape or is hematite; however, in the cases where the temperature concerned is 20° C. or higher and lower than 45° C., the iron oxyhydroxide particles are fine, large in aspect ratio and small in CV value (narrow in particle size distribution).

Additionally, as can be seen, in the case where the oxygen component proportion of the oxygen-containing gas in the step B is 1.0 (Comparative Example 5), the produced iron oxyhydroxide particles are indeterminate-shape; however, in the cases where the concerned oxygen component proportion is 0.5 to 0.8, the iron oxyhydroxide particles are 72 nm or less in long axis length, and are fine, large in aspect ratio and small in CV value.

Further, as can be seen, in the case where the oxidation rate of the ferrous iron in the step B is 20% (Comparative Example 1), the long axis length is 90 nm; however, in the case where the concerned oxidation rate is 67% (Comparative Example 6), the produced iron oxyhydroxide particle is indeterminate-shape. On the other hand, in the cases where the concerned oxidation rate is 30 to 65%, the iron oxyhydroxide particles are fine, large in aspect ratio and small in CV value.

The obtained iron oxyhydroxide particles can be made fine so as to be 75 nm or less in mean long axis length, by applying the following operations: in the step B, the temperature of the suspension solution is decreased, the oxygen-containing gas controlled at a predetermined oxygen component proportion is blown into the suspension solution so as to oxidize part of the ferrous iron; and in the step C, at an elevated temperature, the rest of the ferrous iron is oxidized. The above-described operations also enable the aspect ratio to be made as large as 3 or more, and further the particle size distribution to be made narrow.

What is claimed is:

1. A method for producing an iron oxyhydroxide particle, the method comprising:
a step A of obtaining a ferrous iron-containing suspension solution by mixing an aqueous ferrous salt solution and an aqueous alkali solution containing one or two of an alkali carbonate and an alkali hydroxide;
a step B of obtaining an iron oxyhydroxide particle precursor by blowing an oxygen-containing gas having an oxygen component proportion of 0.5 to 0.8 into the suspension solution obtained in the step A to oxidize the ferrous iron in the suspension solution at an oxidation rate of 30 to 65% while the suspension solution is being controlled to fall in a temperature range of −5° C. or higher and lower than 10° C.; and
a step C of producing iron oxyhydroxide particles from the iron oxyhydroxide particle precursor, after the step B, by blowing an oxygen-containing gas into the suspension solution containing the iron oxyhydroxide particle precursor while the suspension solution is being controlled to fall in a temperature range of 20° C. or higher and lower than 45° C.

2. The method for producing an iron oxyhydroxide particle according to claim 1, wherein in the step A, the concentration of Fe in the ferrous iron-containing suspension solution is 0.001 to 0.1 mol/L.

3. The method for producing an iron oxyhydroxide particle according to claim 2, wherein the concentration of Fe is 0.05 mol/L or less.

4. The method for producing an iron oxyhydroxide particle according to claim 2, wherein the concentration of Fe is 0.01 mol/L or more.

5. The method for producing an iron oxyhydroxide particle according to claim 1, wherein in the step A, the hydrogen ion index pH of the aqueous alkali solution is 9 to 11.

6. The method for producing an iron oxyhydroxide particle according to claim 5, wherein the hydrogen ion index pH of the aqueous alkali solution is 9.5 to 10.5.

7. The method for producing an iron oxyhydroxide particle according to claim 1, wherein the step A is performed in an airtight vessel in which the atmosphere is set to be nonoxidative.

8. The method for producing an iron oxyhydroxide particle according to claim 1, wherein in the step B, the diameter of the gas bubble in the oxygen-containing gas is 0.5 mm or more and less than 2.0 mm.

9. The method for producing an iron oxyhydroxide particle according to claim 1, wherein in the step B, the ferrous iron is oxidized at an oxidation rate of 35 to 50%.

10. The method for producing an iron oxyhydroxide particle according to claim 1, wherein the aqueous ferrous salt solution is an aqueous iron sulfate solution.

11. The method for producing an iron oxyhydroxide particle according to claim 1, wherein sodium hydrogen carbonate is used as the alkali carbonate.

12. The method for producing an iron oxyhydroxide particle according to claim 1, wherein sodium hydroxide is used as the alkali hydroxide.

13. The method for producing an iron oxyhydroxide particle according to claim 1, wherein in the step C, the oxygen component proportion in the oxygen-containing gas is 0.2 to 0.8.

14. The method for producing an iron oxyhydroxide particle according to claim 1, wherein in the step C, the oxygen-containing gas is blown into the suspension solution while the suspension solution is being controlled to fall in a temperature range of 25° C. or higher and lower than 35° C.

15. The method for producing an iron oxyhydroxide particle according to claim 1, wherein the iron oxyhydroxide particles obtained in the step C are needle-like or spindle-like.

16. The method for producing an iron oxyhydroxide particle according to claim 1, wherein the iron oxyhydroxide particles obtained in the step C are 20 to 50 nm in mean long axis length and 3 to 10 in aspect ratio.

17. The method for producing an iron oxyhydroxide particle according to claim 1, wherein the iron oxyhydroxide particle precursor is GR1 that contains a carbonate ion and has a chemical formula [Fe₄^{(II)}Fe₂^{(III)}(OH)¹²][CO₃.2H₂O] or GR2 that contains a sulfate ion and has a chemical formula [Fe₄^{(II)}Fe₂^{(III)}(OH)₁₂][SO₄.2H₂O].

18. The method for producing an iron oxyhydroxide particle according to claim 1, further comprising a step D of subjecting, after the step C, the iron oxyhydroxide particles to a reduction treatment to be converted into metal magnetic particles.

19. The method for producing an iron oxyhydroxide particle according to claim 18, wherein the metal magnetic particles are needle-like.
